(19) United States
(12) Patent Application Publication
(10) Pub. No.: US 2008/0056148 A1
(43) Pub. Date: Mar. 6, 2008

(54) WIRELESS COMMUNICATION METHOD AND APPARATUS FOR REDUCING DATA RETRANSMISSION

(75) Inventor: Jing-Yi Wu, Yilan County (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: MediaTek Inc., Hsin-Chu City (TW)

(21) Appl. No.: 11/470,309

(22) Filed: Sep. 6, 2006

(51) Int. Cl. H04J 1/16

(52) U.S. Cl. 370/252

(57) ABSTRACT

Wireless communication methods and apparatuses for reducing data retransmission are provided. One wireless communication apparatus performs one of the methods comprising the steps of determining whether a reset is triggered; if yes, receiving a status report and transmitting a datum having not been received successfully in response to the status report. Another wireless communication apparatus performs another method comprising the steps of receiving a trigger of a reset; determining what datum having been received successfully in response to the trigger; and generating a status report under a particular condition. The status report indicates the datum having been received successfully.

### CROSS-REFERENCES TO RELATED APPLICATIONS

Not applicable.

### BACKGROUND OF THE INVENTION

1. Field of the Invention

The present invention relates to wireless communication methods and apparatuses for reducing data retransmission. More particularly, the present invention relates to wireless communication methods and apparatuses for reducing data retransmission via a status report indicating what data having been received successfully.

2. Descriptions of the Related Art

Wireless communication technologies have been developed rapidly in recent years. Qualities of wireless communications depend on bandwidth, quality of services (QoS), and error correction ability, etc. Third Generation (3G) wireless communication systems are evolved due to the need of mass multimedia transmission. In 3G access stratum, maintenance of QoS is a kind of service provided by Radio Link Control (RLC) layer, which is also responsible for error recovery and flow control.

The RLC layer consists of RLC entities, of which there are three types: Transparent Mode (TM), Unacknowledged Mode (UM), and Acknowledged Mode (AM). An AM RLC entity consists of a transmitting side and receiving side, where the transmission side of the AM RLC entity transmits RLC PDUs (protocol data unit) and the receiving side of the AM RLC entity receives RLC PDUs. FIG. 1A illustrates the model of the RLC layer. The sender is the sender of PDUs and the receiver is the receiver of PDUs. A sender or a receiver can reside at either the UE or the UTRAN. Besides, an AM RLC entity acts either as a sender or as a receiver depending on the elementary procedure. One of the elementary procedures, which are defined between a sender and a receiver, is RLC reset procedure. The RLC reset procedure is used to reset two RLC peer entities, which operates in acknowledged mode.

During the RLC reset procedure, the hyper frame numbers (HFN) in the sender and the receiver are synchronized. The HFN is one of parameters that are required by RLC for ciphering functions on AM or UM RLC entities.

Based on the protocols for 3G Partnership Project (3GPP), there are three particular conditions that an RLC layer will be triggered to reset. They are that: (1) an AMD PDU is scheduled for transmission for a predetermined number of times, and the sender is configured as not to discard upper layer's PDUs; or (2) a Moving Receiving Window (MRW) control PDU has been transmitted for a predetermined number of times without receipt of a corresponding acknowledgement; or (3) a STATUS protocol data unit (PDU) or a piggybacked STATUS PDU carries an erroneous sequence number.

FIG. 1B illustrates a general AMD PDU transmission between a sender 110 and a receiver 120. FIG. 2 illustrates a RLC reset procedure. As shown in FIG. 1B, the sender 110 sends AMD PDUs (a control PDU 130 and a data PDU 140) to the receiver 120. The receiver 120 acknowledges successful reception or requests retransmission of the missing AMD PDUs by sending a STATUS PDU 150 to the AM RLC peer entity. Generally, if no status report is received, the sender 110 will assume that the previous AMD PDU transmission is not failed and will transmit the following AMD PDUs. Meanwhile, a RLC reset procedure 200 may be performed at anytime. If the acknowledge response from the receiver 120 is not readily received by the sender 110 before a RLC reset procedure 200, after the RLC reset procedure 200 is complete, without knowing whether the receiver 120 has successfully received those transmitted AMD PDUs, the sender 110 has to re-transmit them to the receiver 120 again. It is very inefficient.

Referring to FIG. 2, both of the sender 110 and the receiver 120 comprise an RLC layer. When the sender 110 detects a trigger of the RLC reset it transmits a RESET PDU 230 to the receiver 120. Meanwhile, the sender 110 stops transmitting any Acknowledge mode (AMD) PDU, piggybacked STATUS PDU, or STATUS PDU, and also ignores any incoming AMD PDU, piggybacked STATUS PDU, or STATUS PDU. After receiving the RESET PDU 230, the receiver 120 checks a Reset Sequence Number (RSN) carried by the RESET PDU 230 to decide whether to transmit a corresponding RESET Acknowledgement (ACK) PDU 240 to the sender 110. It is worthy to mention that a status report is useful information for retransmission to both peer RLC entities when the trigger of reset procedure is not in the third case: a STATUS protocol data unit or a piggybacked STATUS PDU carries an erroneous sequence number.

In some circumstances, upper layer's data must be lossless. Those transmitted data that are not acknowledged by the peer RLC entity have to be retransmitted after the RLC reset procedure. For example, the UE might receive AMD PDUs and reassemble those into RLC Service Data Units (SDUs) which are delivered to the upper layer during the moment from transmission of a last status report to receipt of a RESET PDU, and the correct reception of those RLC PDUs that reassembles into RLC SDUS has no opportunity to be acknowledged to the UTRAN because an RLC reset procedure is triggered. However, they are retransmitted by UTRAN after the reset procedure ends because the sender 110 is not acknowledged. The repeated and redundant transmission wastes communication bandwidth and causes problems to the upper layers.

As aforementioned description, a solution to reducing data retransmission during an RLC reset is highly desired in the industrial field.

### SUMMARY OF THE INVENTION

An object of this invention is to provide a wireless communication method for reducing data retransmission during RLC reset procedure. The method comprises the steps of: determining whether a reset is triggered; if yes, determining what datum having been received successfully in response to the trigger and generating a status report under a particular condition. The status report is generated under a particular condition and indicates what datum having been received successfully.

Another object of this invention is to provide a wireless communication method for reducing data retransmission. The method comprises the steps of: receiving a trigger of a reset; determining what datum having been received successfully in response to the trigger; and generating a status report under a particular condition. The status report indicates the datum having been received successfully.

Another object of this invention is to provide a wireless transmission apparatus for reducing data retransmission. The wireless transmission apparatus comprises a first determination unit for determining whether a reset is triggered, and for generating a signal if a reset is determined being triggered; a receiving unit for receiving a status report in response to the signal; and a transmission unit for transmitting a datum having not been received successfully in response to the status report. The status report is generated under a particular condition and indicates what datum having been received successfully.

Yet a further object of this invention is to provide a wireless receiving apparatus for reducing data retransmission. The wireless receiving apparatus comprises a first determination unit for receiving a trigger of a reset; a determination unit for determining what datum having been received successfully in response to the trigger, and a generation unit for generating a status report under a particular condition. The status report indicates the datum having been received successfully.

Once an RLC reset is triggered, the present invention is capable of knowing statuses of transmitted data via a status report. That is, which datum having been received successfully and which datum having not been received successfully are known to the transmitting side of an AM RLC entity. Consequently, the AM RLC entity can simply transmit the datum that has not been received successfully. Reducing data retransmission is thus achieved.

The preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A illustrates an overview model of RLC sublayer.

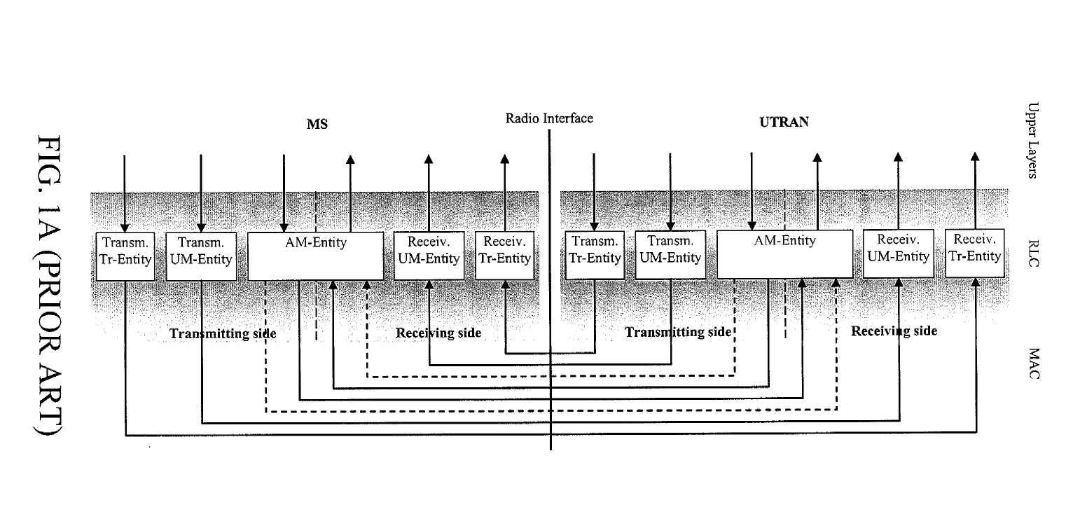

FIG. 1B illustrates a general AMD PDU transmission.

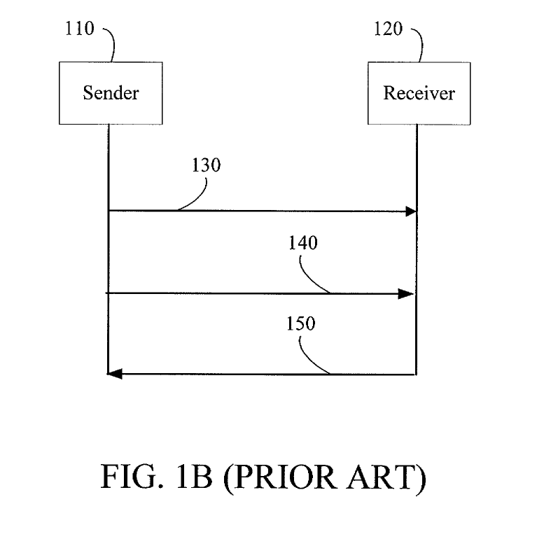

FIG. 2 illustrates an RLC reset procedure of the prior art;

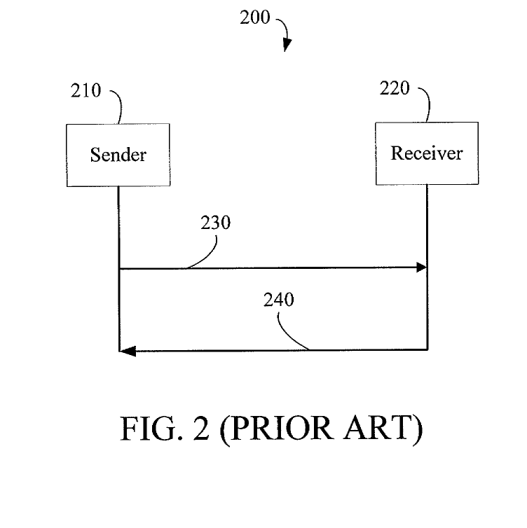

FIG. 3 illustrates an RLC reset procedure of the first embodiment;

FIG. 4 illustrates content of a RESET PDU or a RESET ACK PDU;

FIG. 5 illustrates content of a STATUS PDU;

FIG. 6 illustrates a flowchart for a sender to transmit the RESET PDU in a first embodiment;

FIG. 7 illustrates a flowchart for a receiver to transmit the STATUS PDU and the RESET ACK PDU in the first embodiment;

FIG. 8 illustrates a flowchart for the sender to finish an RLC reset procedure in response to the RESET ACK PDU;

FIG. 9 illustrates an RLC reset procedure of a second embodiment;

FIG. 10 illustrates content of a RESET PDU or a RESET ACK PDU having SUFI fields in the second embodiment;

FIG. 11 illustrates a flowchart for a receiver to transmit the RESET ACK PDU in the second embodiment;

FIG. 12 illustrates an RLC reset procedure of a third embodiment;

FIG. 13 illustrates a flowchart for a sender to transmit the RESET PDU in the third embodiment; and

FIG. 14 illustrates a fourth embodiment of the present invention.

### DESCRIPTION OF THE PREFERRED EMBODIMENT

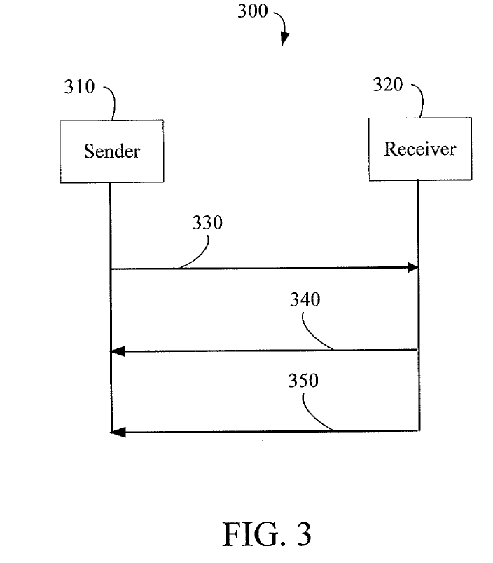

A fist embodiment of this invention is illustrated in FIG. 3, which shows an RLC reset procedure 300 of a wireless communication system. The wireless communication system comprises a sender 310 and a receiver 320. Both the sender 310 and the receiver 320 are 3GPP devices, and comprise one of a Universal Terrestrial Radio Access Network (UTRAN) and User Equipment (UE), respectively.

During communication, the sender 310 may transmit AMD PDUs, which carry data information, to the receiver 320. While transmitting, the sender 310, in some conditions, must perform a reset procedure to prevent transmission errors. When a reset is triggered, the sender 310 composes and transmits a status report for the receiving side of the AM RLC entity, and then traits a RESET PDU 330 to the receiver 320. After receiving the RESET PDU 330, the receiver 320 transmits a STATUS PDU 340, including a status report, to the sender 310. While transmitting the STATUS PDU 340, the receiver 320 transmits a RESET ACK PDU 350 to the sender 310 to confirm the reception of RESET PDU 330. Details of the messages of the RESET PDU 330, the STATUS PDU 340, the RESET ACK PDU 350 will be illustrated later.

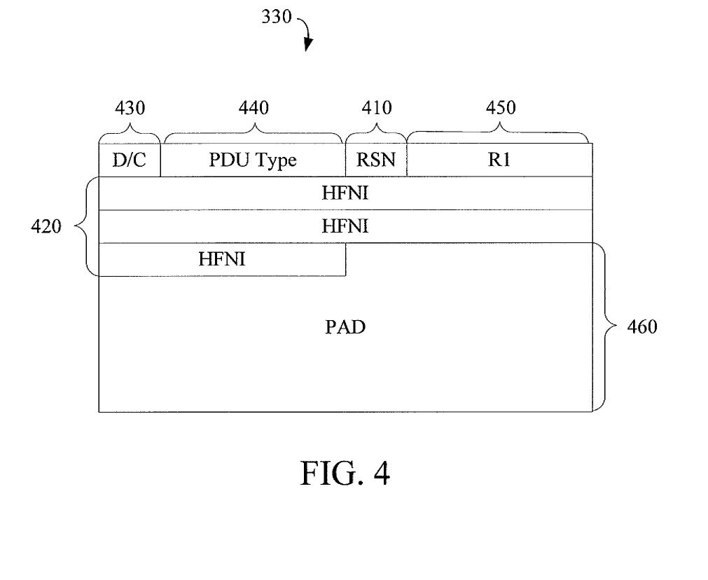

The content of the RESET PDU 330 is shown in FIG. 4, wherein a Reset Sequence Number (RSN) 410 is used to indicate the sequence number of the RESET PDU 330 and a plurality of Hyper Frame Number Indicators (HFNIs) 420 are used to indicate a HFN to the peer entity, i.e. the receiver 320. In addition, a D/C field 430 is configured to indicate the type of an AMD PDU, which can be either a data PDU or a control PDU. A field of PDU Type 440 is configured to indicate the type of the control PDU, which can be a STATUS PDU, a RESET PDU, and a RESET ACK PDU. An R1 field 450 is set for the RESET PDU and the RESET ACK PDU, which shall always be coded to “000” because other values are reserved and will be considered invalid. As to a PAD field 460, all unused space in the RESET PDU 330 shall be located at the end of the PDU 330 and is referred to as padding. Padding shall be of a particular length such that the PDU 330 as a whole has one of the predefined total lengths.

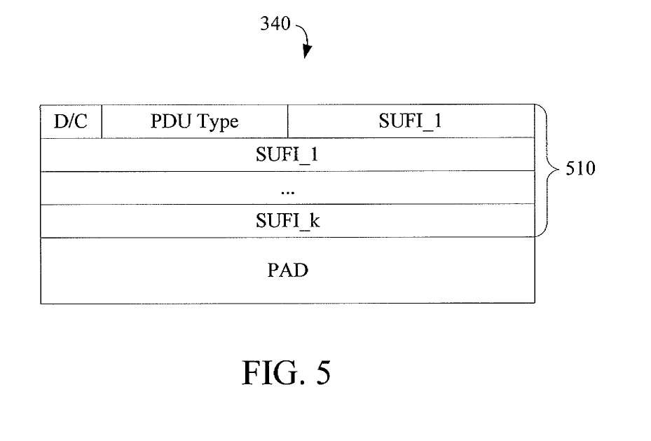

The content of the STATUS PDU 340 is illustrated in FIG. 5, wherein super-fields (SUFIs) 510 are configured to indicate which AMD PDUs have been received and which are missing. The content of the RESET ACK PDU 350 is similar to that of the RESET PDU 330. With the HFNIs 420 in the RESET PDU 330 and the RESET ACK PDU 350, HFNs of the sender 310 and the receiver 320 can be synchronized.

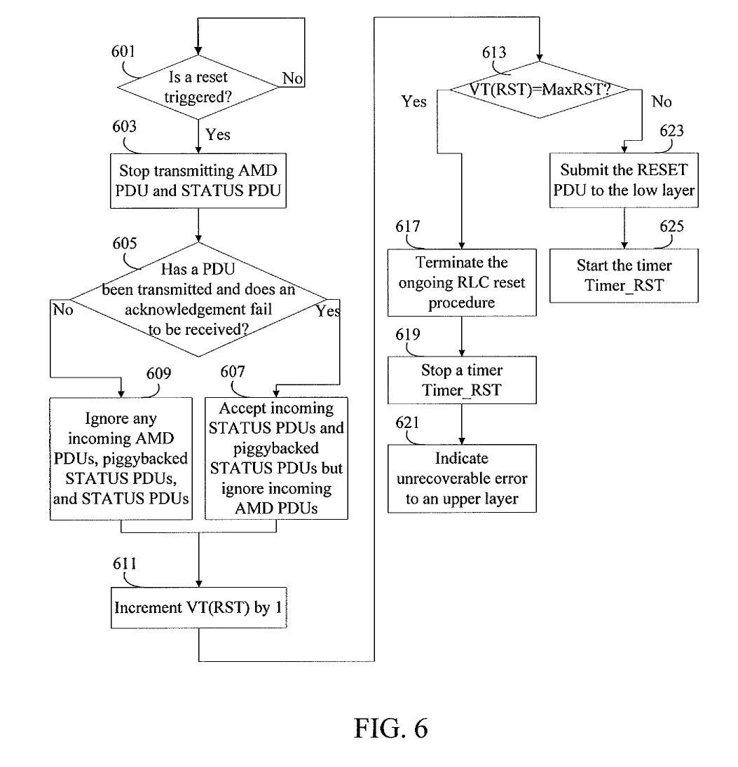

FIG. 6 shows the flow chart of the reset procedure operated at the sender 310. In step 601, the sender 310 first determines whether a reset is triggered. If no in step 601, the sender 310 waits a certain amount of time, like one TTI (transmission time interval), to re-execute step 601. If yes, the sender 310 executes step 603, i.e. stops transmitting AMD PDUs and STATUS PDUs. Next in step 605, the sender 310 determines whether the trigger of the reset results from that a PDU has been transmitted for a predetermined number of times without an acknowledgement. If yes, the sender 310 executes step 607, i.e. accepts any incoming STATUS PDUs and piggybacked STATUS PDUs and ignores incoming AMD PDUs. If no in step 605, the sender 310 executes step 609 to ignore any incoming AMD PDUs, piggybacked STATUS PDUs, and STATUS PDUs. After step 607 or step 609 is executed, the sender 310 increments VT (RST) by one in step 611, wherein VT (RST) is used to count the number of times the reset procedure is triggered (or, the RESET PDU 330 is scheduled to be transmitted). Next, in step 613 the sender 310 determines whether VT (RST) is equal to MaxRST, wherein MaxRST is a predetermined number configured by upper layers. If yes, the sender 310 terminates the ongoing RLC reset procedure in step 617, stops a timer Timer_RST in step 619 if it was started, and indicates an unrecoverable error to an upper layer in step 621, wherein Timer_RST is used to count time associated with the loss of the RESET PDU 330. If no in step 613, the sender 310 submits the RESET PDU 330 to the lower layer in step 623 and then starts the timer Timer_RST in step 625.

Alternatively, the sender 310 may submit a RESET PDU to the lower layer with the content the same as that in step 623 when the answer is yes in step 613.

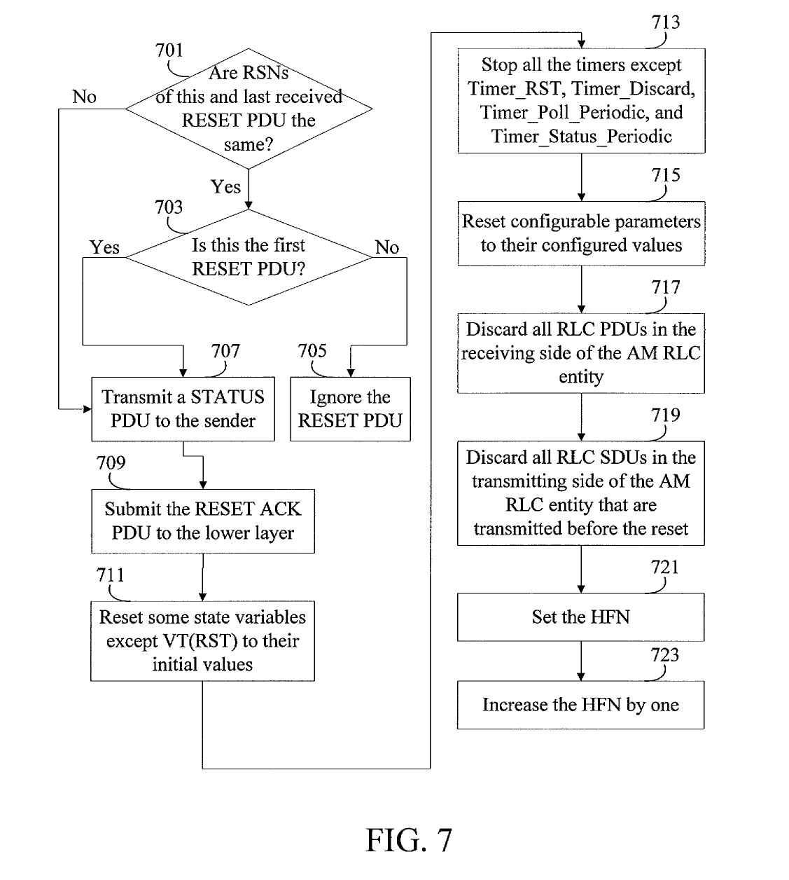

FIG. 7 shows the flow chart of the reset procedure operated at the receiver 320 upon receipt of the RESET PDU 330 from the sender 310. The receiver 320 first executes the steps illustrated in FIG. 7 in response to the RESET PDU 330. In other words, the receiver 320 executes the steps in FIG. 7 to transmit the STAUS PDU 340 and the RESET ACK PDU 350 in response to the RESET PDU 330. Fist, the receiver 320 determines whether the RSN of the RESET PDU 330 is the same as that of a last received RESET PDU in step 701. If the two numbers are different, the receiver 320 executes step 707 directly. If the two RSNs are the same, the receiver 320 further determines whether this is the first RESET PDU since the entity is (re-)established in step 703. If the answer is no, the receiver 320 executes step 705 to ignore the RESET PDU 330. If the answer is yes, the receiver 320 executes step 707 to transit a STATUS PDU 340, i.e., the status report to the sender 310. Next the receiver 320 executes step 709 to submit the RESET ACK PDU 350 to the lower layer and then executes step 711 to reset some related state variables except VT (RST) to their initial values. After that, the receiver 320 stops all related timers except Timer_RST, Timer_Discard, Timer_Poll_Periodic, and Timer_Status_Periodic in step 713, wherein Timer_Discard is triggered when a timer-based SDU discard is configured by upper layers, Timer_Poll_Periodic is triggered when timer-based polling is activated by upper layers, Timer_Status_Periodic is triggered when timer-based status reporting is activated by the upper layers. Next, the receiver 320 resets configurable parameters to their configured values in step 715. Then, the receiver 320 discards all RLC PDUs in a receiving side of the AM RLC entity in step 717 and discards all RLC SDUs in a transmitting side of the AM RLC entity that are transmitted before the reset in step 719. Then, the receiver 320 goes to step 721 to set the HFN equal to that stored in the HFNI field of the RESET PDU 330. In particular, the receiver 320 sets a DL HFN when the RESET ACK PDU 350 is sent by the UTRAN or sets a UL HFN when the RESET ACK PDU 350 is sent by the UE. Finally, the receiver 320 increases the HEN by one in step 723.

Alternatively, the receiver 320 may submit the RESET ACK PDU 350 to the lower layer with the content exactly the same as that in a last transmitted RESET ACK PDU instead of executing steps 703 to 723 when the answer is yes in step 701.

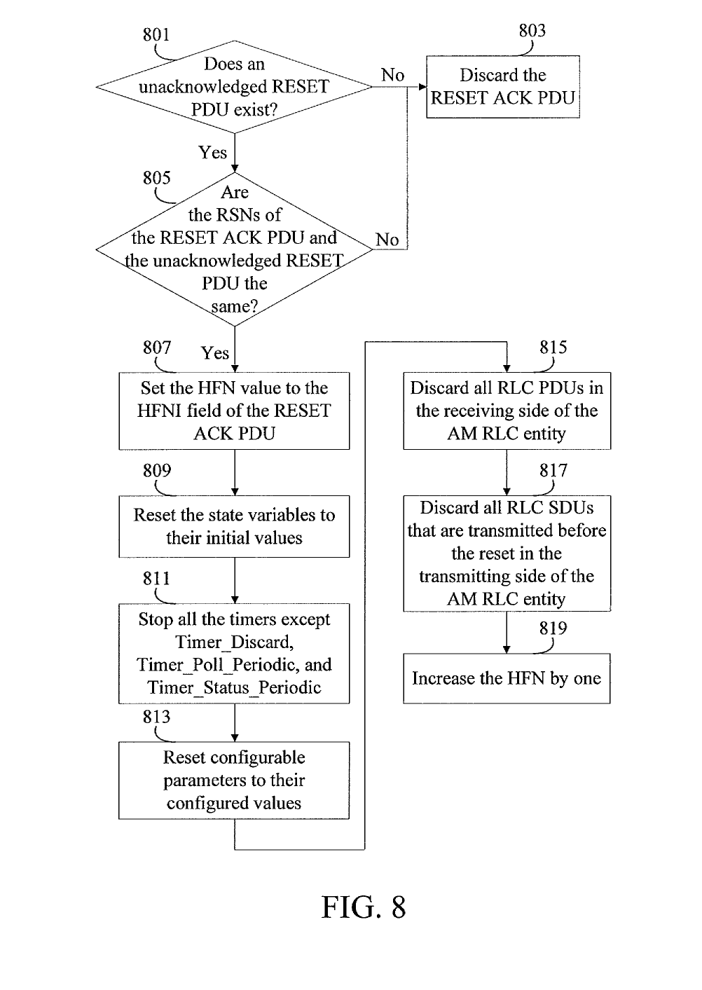

Upon receipt of the RESET ACK PDU 350, the sender 310 executes the steps illustrated in FIG. 8 to finish the RLC reset procedure. First, in step 801 the sender 310 checks whether an unacknowledged RESET PDU already exists. If no, the sender 310 discards the RESET ACK PDU 350 in step 803. If yes, the sender 310 further checks whether the RSNs of the RESET ACK PDU 350 and the unacknowledged RESET PDU are the same in step 805. If the two RSNs are different the sender 310 executes step 803 to discard the REST ACK PDU 350. If the two RSNs are the same, the sender 310 executes step 807 to set the HFN value into the HFNI field of the RESET ACK PDU 350; more particularly, set the DL HFN when the RESET ACK PDU 350 is received in UE or set the UL HFN when the RESET ACK PDU 350 is received in UTRAN. Next the sender 310 resets state variables to their initial values in step 809. After that the sender 310 stops all the timers except Timer_Discard, Timer_Poll_Periodic, and Timer_Status_Periodic in step 811. Then the sender 310 executes step 813 to reset configurable parameters to their configured values. Then, the sender 310 discards all RLC PDUs in the receiving side of the AM RLC entity in step 815 and discards all RLC SDUs that are transmitted before the reset in the transmitting side of the AM RLC entity in step 817. Finally, in step 819 the sender 310 increases the HFN by one. The updated HFN is used after the reset procedure. The RLC reset procedure is now complete. After the RLC reset is complete, the sender 310 transmits a datum having not been received successfully in response to the status report i.e. the STATUS PDU 340.

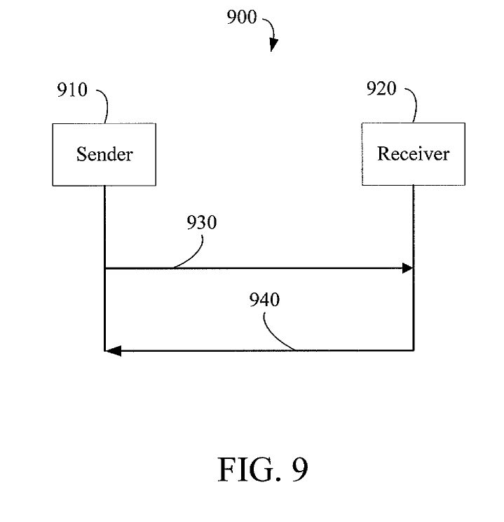

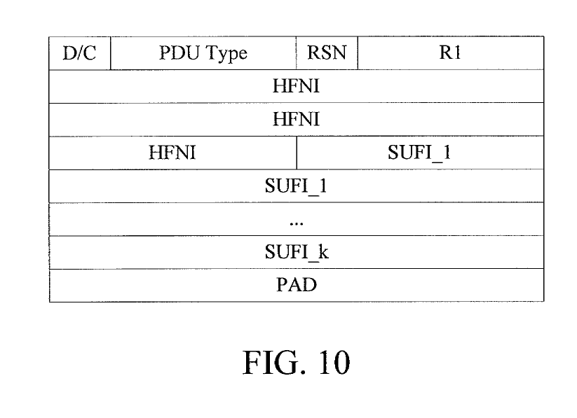

A second embodiment of this invention is illustrated in FIG. 9, which shows an RLC reset procedure 900 of a wireless communication system. The wireless communication system comprises a sender 910 and a receiver 920. When the sender 910 detects a reset is triggered, it transmits a RESET PDU 930 to the receiver 920. An example of the RESET PDU 930 is illustrated in FIG. 10. Then, the receiver 920 generates a status report by transmitting a RESET ACK PDU 940 to the sender 910 in response to the RESET PDU 930. The content of the RESET ACK PDU 940 is similar to that illustrated in FIG. 10. After the RLC reset is complete, the sender 310 transmits a datum having not been received successfully in response to the status report.

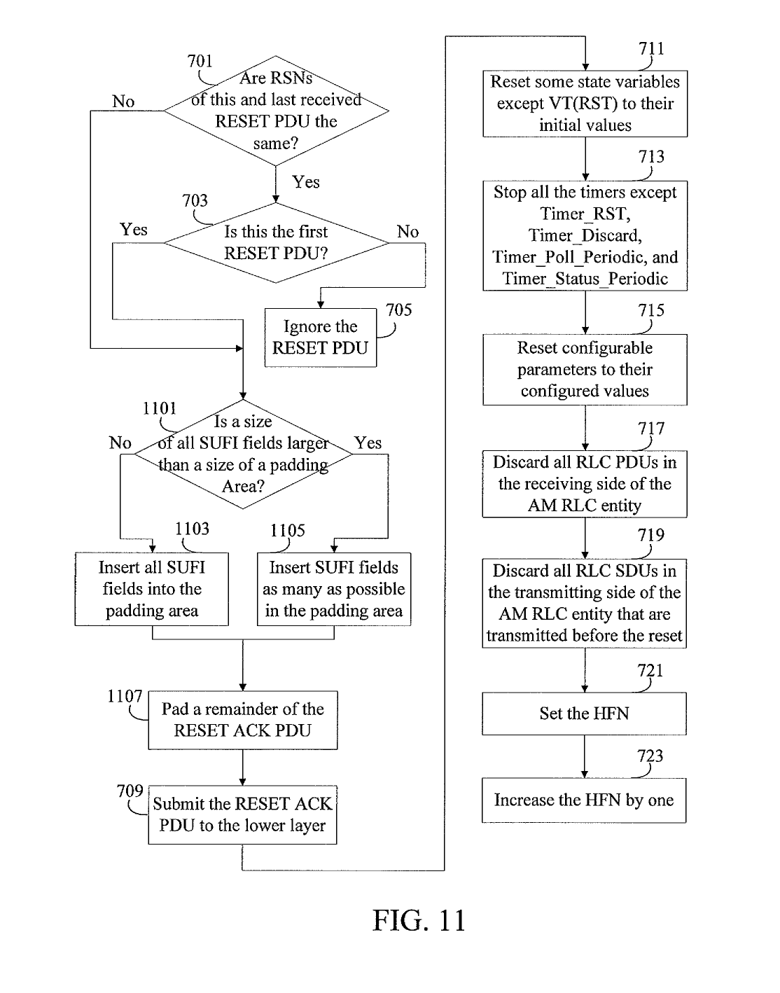

In order to transmit the RESET PDU 930, the sender 910 executes the steps illustrated in FIG. 6. In order to transmit the RESET ACK PDU 940, the receiver 920 executes the steps as illustrated in FIG. 11. Most steps in FIG. 11 are similar to the corresponding steps in FIG. 7, except that steps 1101, 1103, 1105, and 1107 in FIG. 11 replace step 707 in FIG. 7. In this embodiment the receiver 920 inserts the status report into the RESET ACK PDU 940 before transmitting the RESET ACK PDU 940. More particularly, the receiver 920 checks whether the RESET PDU 930 is the first one since the entity is (re-)established in step 703. If yes, the receiver 920 executes step 1101 to check whether a size of all SUFI fields is larger than a size of a padding area of the RESET ACK PDU 940. If no, the receiver 920 inserts all SUFI fields into the padding area of the RESET ACK PDU 940 in step 1103. Otherwise, the receiver 920 inserts SUFI fields as many as possible in the padding area in step 1105. The SUFU fields include information about which AMD PDUs have been received and which are missing. Then, in step 1107, the receiver 920 pads a remainder of the RESET ACK PDU 940 which is not used. The other steps are similar to those in FIG. 6 so the details are not repeated herein.

After receiving the RESET ACK PDU 940, the sender 910 extracts the SUFIs to get data transmission information and, based on the data transmission information, executes steps similar to those illustrated in FIG. 8 to finish the RLC reset. Other than executing steps 703, 705, 1103-1107, and 709-723, the receiver 920 may alternatively submit the RESET ACK PDU 940 to a lower layer with the content exactly the same as that in the last transmitted RESET ACK PDU if the answer is yes in step 701.

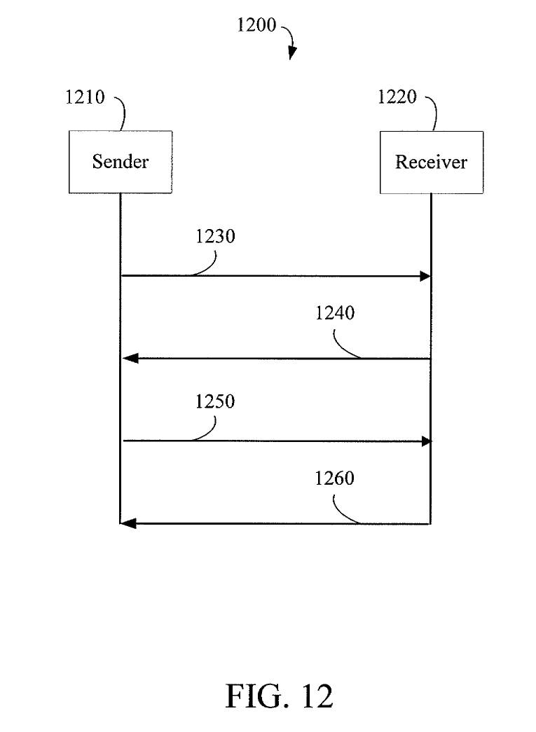

A third embodiment of this invention is illustrated in FIG. 12, which shows an RLC reset procedure 1200 of a wireless communication system. The wireless communication system comprises a sender 1210 and a receiver 1220. In this embodiment, the sender 1210 keeps polling the receiver 1220 for a status report. When the send 1210 triggers a reset procedure, it holds the reset procedure for a predetermined period of time to check if the polling is not prohibited and initiated a polling function 1230 by setting the polling bit. Then, the receiver 1220 transmits a STATUS PDU 1240, i.e., a status report to the sender 1210. After the sender 1210 receives the STATUS PDU 1240, it transmits a RESET PDU 1250 to the receiver 1220. Finally, the receiver transmits a RESET ACK PDU 1260 in response to the RESET PDU 1250.

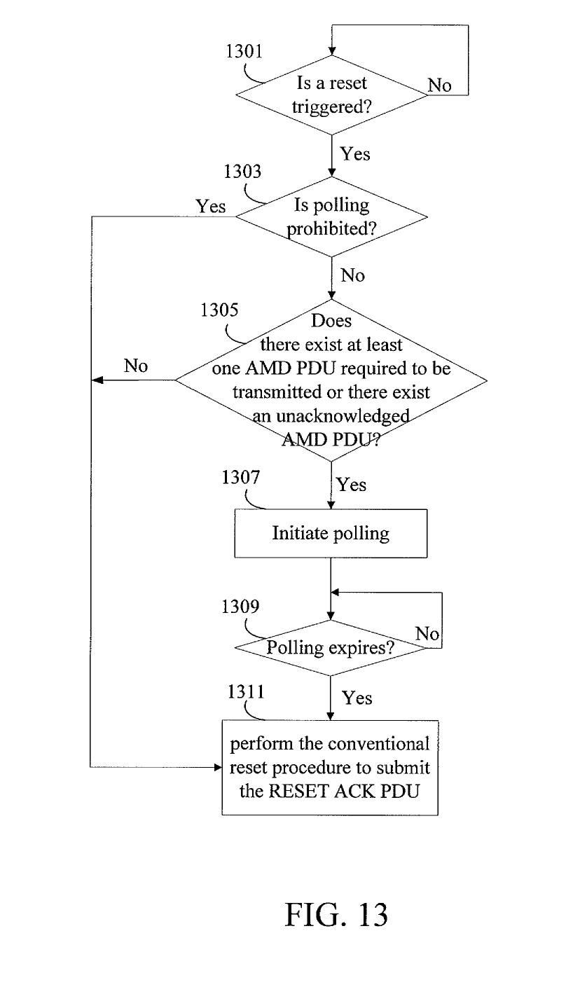

To be more specific, the sender 1210 executes the steps illustrated in FIG. 13. First, the sender 1210 determines whether a reset is triggered in step 1301. If no, the sender 1210 waits a certain amount of time and goes back to step 1301. If yes, the sender 1210 executes step 1303 to see whether polling is prohibited. If yes, the sender 1210 performs the conventional reset procedure to submit the RESET ACK PDU 1260 without generating a status report in step 1311. If no, the sender 1210 goes to step 1305 to hold the reset procedure for a predetermined period of time to check whether there exists an unacknowledged AMD PDU. If no, the sender 1210 goes to step 1311 as well. If yes, the sender 1210 initiates a polling function by setting the polling bit to request a status report in step 1307. Meanwhile, Time_Poll starts to count. Next the sender 1210 goes to step 1309 to check whether Time_Poll is over a predetermined value. If no, the sender 1210 waits for a predetermined time interval and then checks again. If yes, the sender 1210 goes to step 1311 to perform the conventional reset procedure to submit the RESET ACK PDU 1260. After receiving the RESET ACK PDU 1260, the sender 1210 executes the steps illustrated in FIG. 8 to finish the RLC reset. After the RLC reset is complete, the sender 310 transmits a datum having not been received successfully in response to the status report.

The status report of the present invention is generated under some particular conditions. For example, a datum which has been transmitted for a predetermined number of times cannot be discarded, and the sender fail to receive a corresponding acknowledgement; a datum which has been transmitted for a predetermined number of times without receipt of a corresponding acknowledgement and the datum can be discarded; a STATUS PDU or a piggybacked STATUS PDU carries an incorrect sequence number; or there exists an untransmitted datum.

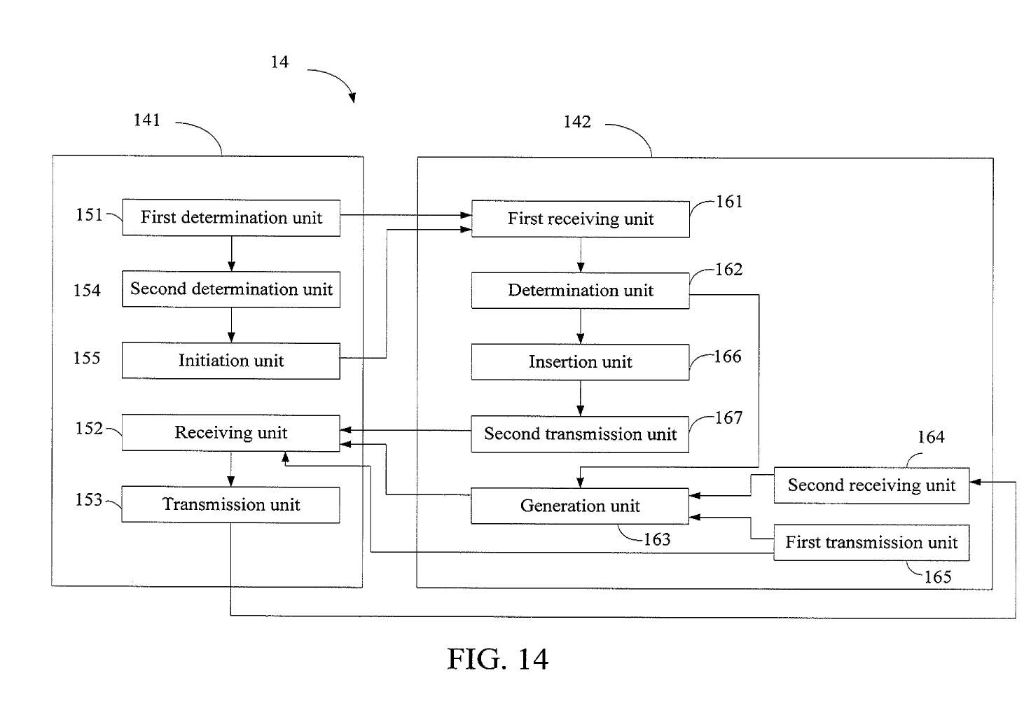

FIG. 14 illustrates a fourth embodiment of the present invention, which is a 3GPP adapted wireless communication system 14. The wireless communication system 14 reduces data retransmission in three alternate approaches, which will be explained later.

The wireless communication system 14 comprises a wireless transmission apparatus 141 and a wireless receiving apparatus 142. The wireless transmission apparatus 141 comprises a first determination unit 151, a receiving unit 152, a transmission unit 153, a second determination unit 154, and an initiation unit 155. The wireless receiving apparatus 142 comprises a first receiving unit 161, a determination unit 162, a generation unit 163, a second receiving unit 164, a first transmission unit 165, an insertion unit 166, and a second transmission unit 167.

The first approach for the wireless communication system 14 to reduce data retransmission is described as follows. The first determination unit 151 is configured to determine whether a reset is triggered. In 3GPP, the trigger of the reset comprises the receipt of a RESET PDU. If the reset is triggered, the first determination unit 151 generates a signal to inform the wireless receiving apparatus 142. The first receiving unit 161 is configured to receive the trigger of the reset. If the receiving unit 161 receives the trigger of the reset the determination unit 162 determines what datum has been received successfully in response to the trigger. Then, the generation unit 163 generates a status report under a particular condition, wherein the status report indicates the datum having been received successfully.

To be more specific, the particular condition is one of the following four conditions: (1) the transmission unit 153 has transmitted a datum for a predetermined number of times and fails to receive an acknowledgement; (2) the second receiving unit 164 for receiving a datum fails to receive a datum that has been transmitted for a predetermined number of times; (3) the first transmission unit 165 for transmitting an acknowledgement fails to transmit an acknowledgement; and (4) the wireless transmission apparatus 141 has an untransmitted datum. More particularly, in 3GPP, the particular condition is that one of a STATUS PDU and a piggybacked STATUS PDU carries an incorrect sequence number, the status report comprises one of a STATUS PDU and a piggybacked STATUS PDU, and the acknowledgement comprises a RESET ACK PDU.

After the generation of the status report, the receiving unit 152 receives the status report, i.e. a STATUS PDU. The transmission unit 153 knows that what datum has been transmitted from the STATUS PDU, so it then transmits datum that has not been received successfully.

The second approach for the wireless communication system 14 to reduce data retransmission is described as follows. After the determination unit 162 determines what datum having been received successfully in response to the trigger, the status report is inserted into the reset acknowledgement. The status report is transmitted within the reset acknowledgement instead of being transmitted directly.

In 3GPP, the reset acknowledgement comprises a RESET ACK PDU. The RESET ACK PDU comprises a padding area. As illustrates in FIG. 5, the STATUS PDU comprises a plurality of SUFIs. To be more specifically, the insertion unit 166 inserts the STATUS PDU into the RESET ACK PDU. The insertion unit 166 determines whether a size of the plurality of SUFIs is larger than a size of the padding area of the reset acknowledgement, i.e. RESET ACK PDU. If the size of the plurality of SUFIs is larger than the size of the padding area, the insertion unit 166 inserts the plurality of SUFIs as many as possible to fill the size of the padding area. If the size of the plurality of SUFIs is not larger than the size of the padding area, the insertion unit 166 inserts all of the SUFIs into the padding area. Then, the second transmission unit 167 transmits the RESET ACK PDU in response to the trigger of the reset. In this way, the wireless transmission apparatus 141 knows what datum has been transmitted from the status report in RESET ACK PDU, so data that have been transmitted will not be retransmitted by the transmission unit 153 again.

The third approach for the wireless communication system 14 to reduce data ret transmission is described as follows. After the first determination unit 151 determines a reset is triggered, the second determination unit 154 determines whether polling is prohibited. If polling is not prohibited, the initiation unit 155 initiates a polling function to request a status report after the reset is triggered. The determination unit 162 determines what datum having been received successfully in response to a request for the polling. Then, the generation unit 163 generates a STATUS PDU.

The first determination unit 151 may execute steps 601-621 illustrated in FIG. 6, i.e. the step of determining whether a reset is triggered and a series of steps executed before the receipt of the status report. The determination unit 162 executes steps 701-723 illustrated in FIG. 7 and FIG. 11, i.e. the steps executed after the wireless receiving apparatus 142 receives the trigger of the reset and before the generation of the status report. The transmission unit 153 executes steps 801-819, i.e. the steps after the wireless transmission apparatus 141 receives the status report (a STATUS PDU or a RESET ACK PDU). The insertion unit 166 executes steps 1101-1107 illustrated in FIG. 11, i.e. the steps to insert the status report into the reset acknowledgement. The second determination unit 154 executes steps 1303 and 1305 illustrated in FIG. 13, i.e. the steps to determine whether polling is prohibited. The initiation unit 155 executes steps 1307 and 1309 illustrated in FIG. 13, i.e. the steps to initiate a polling function to request the status report. In addition to the aforementioned description, the wireless communication system 14 can executes all the functions described in the first, the second, and the third embodiments.

It is worth to mention that the first determination unit 151, the receiving unit 152, the transmission unit 153, the second determination unit 154, the initiation unit 155, the first receiving unit 161, the determination unit 162, the generation unit 163, the second receiving unit 164, the first transmission unit 165, the insertion unit 166, and the second transmission unit 167 may be implemented with a processor of a mobile phone, a portable device, a computer, a router, or the like that are adaptive for 3GPP.

Once an RLC reset is triggered, the present invention is capable of knowing statuses of transmitted data via a status report. That is, which datum having been received successfully and which datum having not been received successfully are known to the sender. Consequently, the sender can simply transmit the datum that has not been received successfully. Reducing data retransmission is thus achieved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A wireless communication method for reducing data retransmission, comprising the steps of:
determining whether a reset is triggered, if yes, executing the following steps;
receiving a status report; and
transmitting a datum having not been received successfully in response to the status report;
wherein the status report is generated under a particular condition and indicates what datum having been received successfully.

2. The wireless communication method of claim 1, wherein the particular condition is that a datum has been transmitted for a predetermined number of times and an acknowledgement fails to be received.

3. The wireless communication method of claim 1, wherein the wireless communication method is adapted for third Generation Partnership Project (3GPP), and the particular condition is that one of a STATUS Protocol Data Unit (PDU) and a piggybacked STATUS PDU carries an incorrect sequence number.

4. The wireless communication method of claim 1, wherein the particular condition is that there exists an untransmitted datum.

5. The wireless communication method of claim 1, wherein the wireless communication method is adapted for 3GPP, the trigger of the reset comprises a RESET PDU, the status report comprises one of a STATUS PDU and a piggybacked STATUS PDU, and the acknowledgement comprises an Acknowledgement (ACK) PDU.

6. The wireless communication method of claim 1, wherein the receiving step is receiving a reset acknowledgement and the transmitting step responds to the reset acknowledgement.

7. The wireless communication method of claim 1, the wireless communication method being adapted for 3GPP, the wireless communication method further comprising the steps of:
determining whether polling is prohibited; and
initiating a polling function to request the status report after the step of determining whether the reset is triggered is executed if polling is determined not prohibited.

8. A wireless communication method for reducing data retransmission, comprising the steps of:
receiving a trigger of a reset;
determining what datum having been received successfully in response to the trigger; and
generating a status report under a particular condition, wherein the status report indicates the datum having been received successfully.

9. The wireless communication method of claim 8, wherein the particular condition is that a datum has been transmitted for a predetermined number of times and an acknowledgement fails to be received.

10. The wireless communication method of claim 8, wherein the wireless communication method is adapted for third Generation Partnership Project (3GPP) and the particular condition is that one of a STATUS Protocol Data Unit (PDU) and a piggybacked STATUS PDU carries an incorrect sequence number.

11. The wireless communication method of claim 8, wherein the particular condition is that there exists an untransmitted datum.

12. The wireless communication method of claim 8, wherein the wireless communication method is adapted for 3GPP, the trigger of the reset comprises a RESET PDU, the status report comprises one of a STATUS PDU and a piggybacked STATUS PDU, and the acknowledgement comprises an Acknowledgement (ACK) PDU.

13. The wireless communication method of claim 8, further comprising the steps of:
inserting the status report into a reset acknowledgement; and
transmitting the reset acknowledgement in response to the trigger of the reset.

14. The wireless communication method of claim 13, the wireless communication method being adapted for 3GPP, the trigger comprising receiving a RESET PDU, the status report comprising a plurality of super fields (SUFIs), the reset acknowledgement comprising a RESET ACK PDU, the RESET ACK PDU comprising a padding area, wherein the inserting step comprises:
determining whether a size of the plurality of SUFIs is larger than a size of the padding area;
inserting the plurality of SUFIs as many as possible to fill the size of the padding area if the size of the plurality of SUFIs is determined larger than the size of the padding area; and
inserting all of the SUFIs into the padding area if the size of the plurality of SUFIs is determined not larger than the size of the padding area.

15. The wireless communication method of claim 8, the wireless communication method being adapted for 3GPP, the step of determining what datum having been received successfully responding to a request for the status report, wherein the request is an initiated polling function after the reset being determined triggered.

16. A wireless transmission apparatus for reducing data retransmission, comprising:
a first determination unit for determining whether a reset is triggered, and if yes, for generating a signal;
a receiving unit for receiving a status report in response to the signal; and
a transmission unit for transmitting a datum having not been received successfully in response to the status report;
wherein the status report is generated under a particular condition and indicates what datum having been received successfully.

17. The wireless transmission apparatus of claim 16, wherein the particular condition is that the transmission unit has transmitted a datum for a predetermined number of times and fails to receive an acknowledgement.

18. The wireless transmission apparatus of claim 16, wherein the wireless transmission apparatus is adapted for 3GPP, and the particular condition is that one of a STATUS PDU and a piggybacked STATUS PDU carries an incorrect sequence number.

19. The wireless transmission apparatus of claim 16, wherein the particular condition is that the wireless transmission apparatus has an untransmitted datum.

20. The wireless transmission apparatus of claim 16, wherein the wireless transmission apparatus is adapted for 3GPP, the trigger of the reset comprises receiving a RESET PDU, the status report comprises one of a STATUS PDU and a piggybacked STATUS PDU, and the acknowledgement comprises an RESET ACK PDU.

21. The wireless transmission apparatus of claim 16, wherein the receiving unit receives a reset acknowledgement and the transmission unit transmits a datum having not been received successfully in response to the reset acknowledgement.

22. The wireless transmission apparatus of claim 16, the wireless transmission apparatus being adapted for 3GPP, further comprising:
a second determination unit for determining whether polling is prohibited; and
an initiation unit for initiating a polling function to request the status report after the reset is triggered if polling is determined not prohibited.

23. A wireless receiving apparatus for reducing data retransmission, comprising:
a first receiving unit for receiving a trigger of a reset;
a determination unit for determining what datum having been received successfully in response to the trigger; and
a generation unit for generating a status report under a particular condition, wherein the status report indicates the datum having been received successfully.

24. The wireless receiving apparatus of claim 23, further comprising:
a second receiving unit for receiving a datum; and
a first transmission unit for transmitting an acknowledgement;
wherein the particular condition is that the second receiving unit fails to receive a datum that has been transmitted for a predetermined number of times or an acknowledgement transmitted by the first transmission unit fails to be transmitted.

25. The wireless receiving apparatus of claim 23, wherein the wireless receiving apparatus is adapted for 3GPP, and the particular condition is that one of a STATUS PDU and a piggybacked STATUS PDU carries an incorrect sequence number.

26. The wireless receiving apparatus of claim 23, wherein the particular condition is that there exists an untransmitted datum.

27. The wireless receiving apparatus of claim 23, wherein the wireless receiving apparatus is adapted for 3GPP, the trigger of the reset comprises receiving a RESET PDU, the status report comprises one of a STATUS PDU and a piggybacked STATUS PDU, and the acknowledgement comprises an RESET ACK PDU.

28. The wireless receiving apparatus of claim 23, further comprising:
an insertion unit for inserting the status report into a reset acknowledgement; and
a second transmission unit for transmitting the reset acknowledgement in response to the trigger of the reset.

29. The wireless receiving apparatus of claim 28, the wireless receiving apparatus being adapted for 3GPP, the trigger comprising receiving a RESET PDU, the status report comprising a plurality of SUFIs, the reset acknowledgement comprising a RESET ACK PDU, the RESET ACK PDU comprising a padding area, wherein the insertion unit determines whether a size of the plurality of SUFIs is larger than a size of the padding area, inserts the plurality of SUFIs as many as possible to fill the size of the padding area if the size of the plurality of SUFIs is determined larger than the size of the padding area, and inserts all of the SUFIs into the padding area if the size of the plurality of SUFIs is determined not larger than the size of the padding area.

30. The wireless receiving apparatus of claim 23, the wireless receiving apparatus being adapted for 3GPP, the determination unit determining what datum having been received successfully in response to a request for the status report, wherein the request is an initiated polling function after the reset being determined triggered.
